(19) United States
(12) Patent Application Publication
(10) Pub. No.: US 2016/0065254 A1
(43) Pub. Date: Mar. 3, 2016

(54) RF TRANSMITTER SUPPORTING CARRIER AGGREGATION AND ENVELOPE TRACKING

(71) Applicant: Electronics and Telecommunications Research Institute, Daejeon (KR)

(72) Inventors: Mi-Jeong PARK, Daejeon (KR); Mun-Yang PARK, Daejeon (KR); Dong-Woo KANG, Daejeon (KR); Jang-Hong CHOI, Daejeon (KR)

(21) Appl. No.: 14/835,111

(22) Filed: Aug. 25, 2015

(30) Foreign Application Priority Data
Aug. 28, 2014 (KR) 10-2014-0113118

(51) Int. Cl. H04B 1/04; H04B 17/13

(52) U.S. Cl. CPC H04B 1/0475; H04B 17/13; H04B 2001/0416

(57) ABSTRACT

Exemplary embodiments of the present invention relate to an RF transmitter supporting carrier aggregation and envelope tracking and an RF transmitter according to an embodiment of the present invention comprises an RF path configured to convert a carrier aggregation signal in which a plurality of component carriers belonging to a baseband are aggregated into an RF signal; an ET path configured to generate an envelope signal by calculating magnitudes of the plurality of component carriers, respectively, and adding the calculated each magnitude of the component carriers; and an amplifier configured to power-amplify the converted RF signal according to a bias voltage corresponding to the generated envelope signal. According to exemplary embodiments of the present invention, power amplification efficiency and data transmission efficiency are improved by applying carrier aggregation and envelope tracking.

### CROSS REFERENCE TO RELATED APPLICATION

This application claims the benefit of Korean Patent Application No. 10-2014-0113118, filed on Aug. 28, 2014, entitled “RF transmitter supporting carrier aggregation and envelope tracking”, which is hereby incorporated by reference in its entirety into this application.

### BACKGROUND

1. Technical Field

Exemplary embodiments of the present invention relate to an RF transmitter supporting carrier aggregation and envelope tracking.

2. Description of the Related Art

Carrier aggregation (CA) is to transmit very high data rates and to aggregate and manage a plurality of frequency bandwidths. For example, 3GPP LTE (3rd Generation Partnership Project Long Term Evolution)-Advanced allows the aggregation of up to 5 component carriers, each having a bandwidth of 20 MHz. New transmission structures are thus required to attain a wideband signal having a total transmission bandwidth of up to 100 MHz to adapt LTE-Advanced.

On the other hand, envelope tracking (ET) has been introduced to increase efficiency of a power amplifier which is used in radio frequency transmitters.

A communication system, in which carrier aggregation and envelope tracking are combined, allows not only wideband signal transmissions but also high power efficiency.

However, when the ET technology is applied as shown in FIG. 1, an envelope signal can have a bandwidth which is at least 3 times greater than that of a transmission signal (I/Q input signal). For example, when a bandwidth of a transmission signal is 100 MHz, an envelope signal can have a bandwidth of about 300 MHz. Therefore, not only digital signal processing devices but also analog signal processing devices which are present in an ET path must process such wideband signals.

### SUMMARY

Exemplary embodiments of the present invention provide an RF transmitter supporting carrier aggregation and envelope tracking.

An RF transmitter according to an embodiment of the present invention may comprise an RF path configured to convert a carrier aggregation signal, in which a plurality of component carriers belonging to a baseband are aggregated, into an RF signal; an ET path configured to generate an envelope signal by calculating magnitudes of the plurality of component carriers, respectively, and adding the calculated magnitudes of the component carriers; and an amplifier configured to power-amplify the converted RF signal according to a bias voltage corresponding to the generated envelope signal.

The RF transmitter may further comprise a baseband processor configured to output the carrier aggregation signal to the RF path and output each of the plurality of component carriers to the ET path.

The ET path may comprise a signal magnitude calculator configured to calculate each magnitude of the component carriers received from the baseband processor; and an adder configured to add signals received from the signal magnitude calculator.

Any one component carrier of the plurality of component carriers may have a frequency band that is contiguous with a frequency band of at least one another component carrier.

An RF transmitter according to an embodiment of the present invention may comprise an RF path configured to convert a first baseband signal and a second baseband signal into one radio frequency signal, the first baseband signal and second baseband signal each comprising at least one component carrier; an ET path configured to generate an envelope signal by calculating magnitudes of the component carriers, respectively, included in the first baseband signal and the second baseband signal and adding the calculated magnitudes of the component carriers; and an amplifier configured to power-amplify the converted RF signal according to a bias voltage corresponding to the generated envelope signal.

The RF transmitter may further comprise a first baseband processor configured to output the first baseband signal to the RF path and output each component carrier included in the first baseband signal to the ET path; and a second baseband processor configured to output the second baseband signal to the RF path and output each component carrier included in the second baseband signal to the ET path.

The ET path may comprise a first signal magnitude calculator configured to calculate magnitudes of the component carriers, respectively, received from the first baseband processor; a second signal magnitude calculator configured to calculate magnitudes of the component carriers, respectively, received from the second baseband processor; and an adder configured to add signals received from the first signal magnitude calculator and the second signal magnitude calculator.

The component carriers included in the first baseband signal may have frequency bands that are contiguous and the component carriers included in the second baseband signal may have frequency bands that are contiguous. Any one component carrier included in the first baseband signal may have a frequency band that is not contiguous with a frequency band of any one component carrier included in the second baseband signal.

The RF signal converted in the RF path may be a carrier aggregation signal in which the first baseband signal and the second baseband signal are aggregated.

Some of the component carriers included in the carrier aggregation signal may have frequency bands that are not contiguous with one another.

An RF transmitter according to another embodiment of the present invention may comprise an RF path configured to convert a first baseband signal and a second baseband signal into one radio frequency signal, the first baseband signal and the second baseband signal each comprising at least one component carrier; an ET path configured to generate an envelope signal by frequency shifting the component carriers included in the first baseband signal and the second baseband signal based on a set frequency band, aggregating the frequency shifted signals, and calculating magnitude for the aggregated signal; and an amplifier configured to power-amplify the converted RF signal according to a bias voltage corresponding to the generated envelope signal.

Any one component carrier included in the first baseband signal may has a frequency band that is not contiguous with a frequency band of any one component carrier included in the second baseband signal.

The ET path according to exemplary embodiments of the present invention may comprise a signal shaper configured to shape the generated envelope signal by using a predetermined variable value. The variable value may comprise at least one of a gain value which is used to shape magnitude of the envelope signal, an offset value which is used to increase/decrease an output DC level of the envelope signal, a maximum threshold which is used to control a maximum value of the envelope signal, and a minimum threshold which is used to control a minimum value of the envelope signal.

According to exemplary embodiments of the present invention, power amplification efficiency and data transmission efficiency are improved by applying carrier aggregation and envelope tracking.

According to exemplary embodiments of the present invention, since an envelope signal of narrowband is generated while using a carrier aggregation signal, conventional envelope tracking-related elements, which are used in envelope tracking systems not supporting carrier aggregation, can be used as they are.

### BRIEF DESCRIPTION OF DRAWING

FIG. 1 is an exemplary view illustrating bandwidth relation between a transmission signal and an envelope signal.

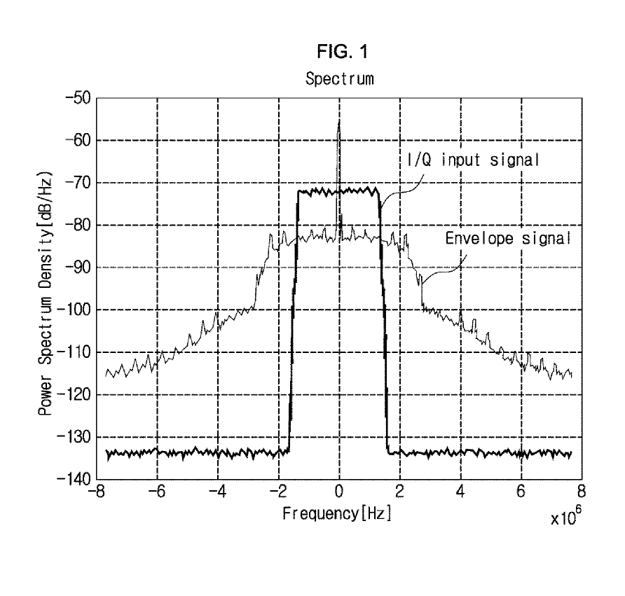

FIG. 2 is an exemplary view illustrating types of carrier aggregations in which exemplary embodiments of the present invention are applied.

FIG. 3 is a block view illustrating an RF transmitter in which carrier aggregation is applied.

FIG. 4 is a block view illustrating an RF transmitter in which carrier aggregation and envelope tracking are applied.

FIG. 5 is a block view illustrating an RF transmitter supporting carrier aggregation and envelope tracking according to an embodiment of the present invention.

FIG. 6 is a block view illustrating another RF transmitter in which carrier aggregation is applied.

FIG. 7 is a block view illustrating an RF transmitter in which carrier aggregation and envelope tracking are applied according to another embodiment of the present invention.

FIG. 8 is a block view illustrating an RF transmitter supporting carrier aggregation and envelope tracking according to still another embodiment of the present invention.

FIG. 9 illustrates an envelope signal (z) generated in an embodiment described with reference to FIG. 4 and FIG. 7 and an envelope signal (y) generated in an embodiment described with reference to FIG. 5 and FIG. 8.

FIG. 10 illustrates a signal shaping process according to exemplary embodiments of the present invention.

FIG. 11 is a block view illustrating a signal shaper according to an embodiment of the present invention.

### DESCRIPTION OF THE EXEMPLARY EMBODIMENTS

Throughout the description of the present invention, when describing a certain technology is determined to evade the point of the present invention, the pertinent detailed description will be omitted.

Hereinafter, throughout the description of the present invention, a signal in which a plurality of baseband signals are aggregated by carrier aggregation is called as a carrier aggregation signal for convenience of description.

Hereinafter, throughout the description of the present invention, each baseband signal before a plurality of baseband signals are aggregated by carrier aggregation is called as a component carrier for convenience of description.

Exemplary embodiments of the present invention will be described with reference to the accompanying drawings.

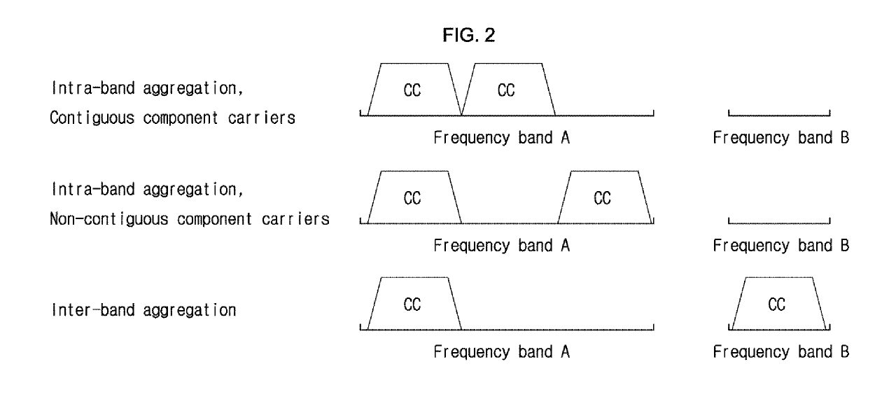

FIG. 2 is an exemplary view illustrating types of carrier aggregations in which exemplary embodiments of the present invention are applied.

Exemplary embodiments of the present invention may be used for carrier aggregation of component carriers belonging to an intra-band or an inter-band, and may be also used for carrier aggregation of component carriers of which a frequency band is contiguous or non-contiguous.

For example, as shown in FIG. 2, exemplary embodiments of the present invention may be used for carrier aggregation of component carriers which are contiguous each other and belonged to a frequency band A, component carriers which are non-contiguous each other and belonged to a frequency band A, or component carriers belonged to a frequency band A or a frequency band B.

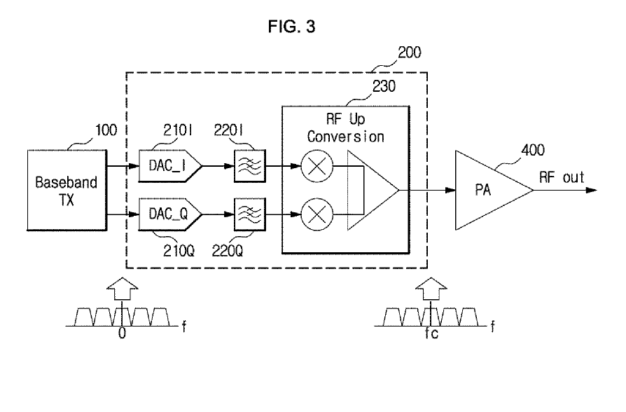

FIG. 3 is a block view illustrating an RF transmitter in which carrier aggregation is applied. FIG. 3 illustrates that 5 baseband signals, which belong to an intra-band and are contiguous, are aggregated through carrier aggregation and RF-treated.

Referring to FIG. 3, an RF transmitter comprises a baseband processor 100, an RF path 200 and a power amplifier 400.

The baseband processor 100 aggregates a plurality of component carriers having a bandwidth to generate one carrier aggregation signal. In case of a LTE-A system, the baseband processor 100 may aggregate 5 component carriers, each having a bandwidth of 20 MHz, to generate one carrier aggregation signal having a bandwidth of 100 MHz.

The RF path 200 RF-treats the carrier aggregation signal received from the baseband processor 100, in which the RF-treating means converting a carrier aggregation signal belonging to the baseband into an RF signal. The RF path 200 comprises digital to analog converters (DAC) 210I, 210Q, low pass filters (LPF) 220I, 220Q and an RF up converter 230.

The digital to analog converter 210I, 210Q converts digital I/Q signal received from the baseband processor 100 to an analog signal.

The low pass filter 220I, 220Q eliminates a noise signal except a transmission signal from the analog I/Q signal received from the digital to analog converter 210I, 210Q.

The RF up converter 230 up-converts the transmission signal present around DC (direct current) voltage into a frequency of a desired channel.

The power amplifier 400 power-amplifies the RF signal which is frequency-converted by the RF up converter 230.

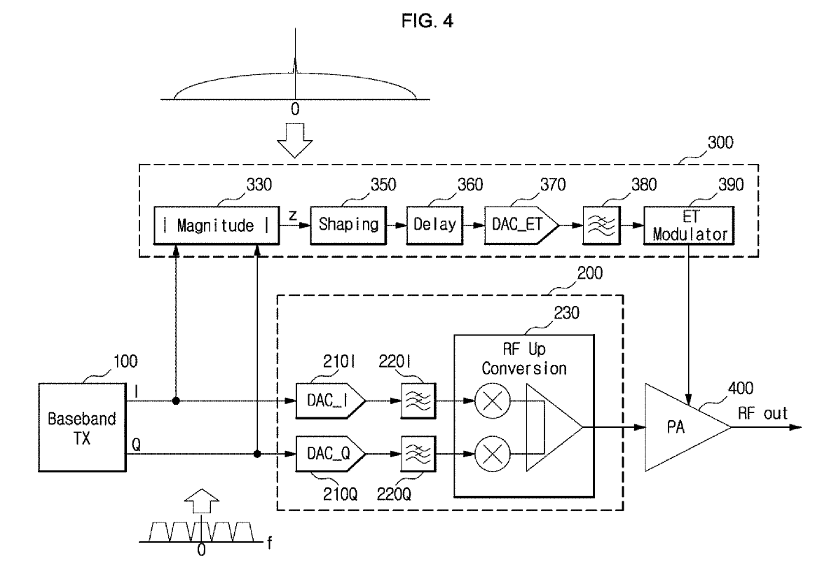

FIG. 4 is a block view illustrating an RF transmitter in which carrier aggregation and envelope tracking are applied.

Like FIG. 3, FIG. 4 illustrates that 5 component carriers, which are an intra-band and are contiguous, are aggregated and RF-treated. Referring to FIG. 4, an RF transmitter comprises a baseband processor 100, an RF path 200, an ET path 300 and a power amplifier 400. Detail description of the RF path 200 will be omitted since it is the same as described with reference to FIG. 3.

The baseband processor 100 aggregates a plurality of component carriers having a bandwidth to generate one carrier aggregation signal. The baseband processor 100 outputs the generated carrier aggregation signal to the RF path 200 and the ET path 300.

The ET path 300 generates an envelope signal by envelope tracking. The envelope signal is then used to generate a bias voltage to be provided to the power amplifier 400. The bias voltage is used for the power amplifier 400 to power-amplify the RF signal which is converted by the RF path 200. The ET path 300 comprises a signal magnitude calculator 330, a signal shaper 350, a delayer 360, a DAC_ET 370, a low pass filter 380 and an ET modulator 390.

The signal magnitude calculator 330 calculates magnitude (z) of a transmission signal which is received from the baseband processor 100. The transmission signal is a digital I/Q signal and magnitude (z) of the transmission signal may be calculated by the following Equation 1.

z=\sqrt{I²+Q²} Equation 1

The signal shaper 350 converts the magnitude of the signal calculated by the signal magnitude calculator 330 into a value corresponding to a bias voltage.

The delayer 360 matches synchronization of the RF path 200 and the ET path 300. The delayer 360 may, for example, match synchronization of the RF path 200 and the ET path 300 by integer multiple or decimal multiple of a reference clock.

The DAC_ET 370 converts a digital envelope signal into an analog envelope signal.

The low pass filter 380 eliminates noise signals except the envelope signal.

The ET modulator 390 modulates the envelope signal to a bias voltage of the power amplifier 400.

The power amplifier 400 power-amplifies the RF signal received from the RF path 200 based on the envelope signal received from the ET path 300. When it is compared with the example described with reference to FIG. 3, efficiency of the power amplifier is improved since power amplification is performed by using the bias voltage which changes with the RF signal.

When a carrier aggregation signal having a bandwidth of 100 MHz is outputted from the baseband processor 100, effective bandwidth of the signal which is calculated by the signal magnitude calculator 330 is 300 MHz which is increased by about three times, compared to 100 MHz.

A sampling rate, which is needed to generate an envelope signal, requires at least twice the signal bandwidth, which is 600 MHz or more. This means that all digital signal processing blocks should operate with 600 MHz or more.

Furthermore, a digital to analog converter, a low pass filter and an ET modulator which are able to process 300 MHz bandwidth are required but it is still practically hard to adopt these elements processing wideband signals.

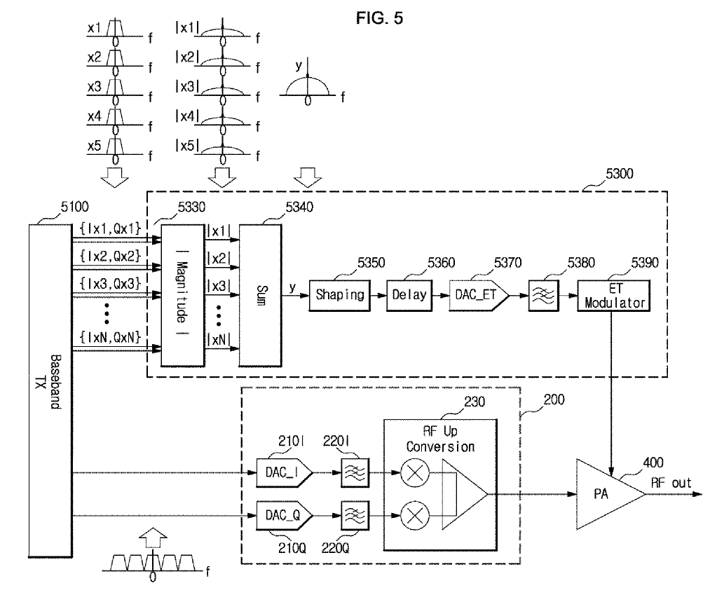

FIG. 5 is a block view illustrating an RF transmitter supporting carrier aggregation and envelope tracking according to an embodiment of the present invention.

FIG. 5 illustrates that 5 component carriers, which are an intra-band and are contiguous, are aggregated and RF-treated. Referring to FIG. 5, an RF transmitter according to an embodiment of the present invention comprises a baseband processor 5100, an RF path 200, an ET path 5300 and a power amplifier 400. Detail description of the RF path 200 will be omitted since it is the same as described with reference to FIG. 4.

The baseband processor 5100 outputs a plurality of component carriers to the ET path 5300.

The baseband processor 5100 aggregates the plurality of component carriers to generate a carrier aggregation signal and outputs the generated carrier aggregation signal to the RF path 200.

For example, when 5 component carriers, each having a bandwidth of 20 MHz, are used, the baseband processor 5100 outputs the 5 component carriers to the ET path 5300 and generates a carrier aggregation signal having a bandwidth of 100 MHz by carrier aggregation of the 5 component carriers to output to the RF path 200.

The ET path 5300 generates an envelope signal through envelope tracking. The envelope signal is used to generate a bias voltage to be provided to the power amplifier 400. The bias voltage is used for the power amplifier 400 to power-amplify the RF signal which is converted by the RF path 200. The ET path 5300 comprises a signal magnitude calculator 5330, a signal adder 5340, a signal shaper 5350, a delayer 5360, DAC_ET 5370, a low pass filter 5380 and an ET modulator 5390. According to embodiments, at least one component thereof may be omitted.

The signal magnitude calculator 5330 calculates each magnitude of the component carriers received from the baseband processor 5100.

For example, when it is assumed that 5 component carriers (x1, x2, x3, x4, x5), each having a bandwidth of 20 MHz, are received from the baseband processor 5100, the signal magnitude calculator 5330 calculates magnitude (|x1|, |x2|, |x3|, |x4|, |x5|) of each component carrier as shown in Equation 2. In Equation 2, Iₓₙ represents I signal of the n^{th} component carrier and Qₓₙ represents Q signal of the n^{th} component carrier.

|x1|=\sqrt{I²ₓ₁+Q²ₓ₁}

|x2|=\sqrt{I²ₓ₂+Q²ₓ₂}

|x3|=\sqrt{I²ₓ₃+Q²ₓ₃}

|x4|=\sqrt{I²ₓ₄+Q²ₓ₄}

|x5|=\sqrt{I²ₓ₅+Q²ₓ₅} Equation 2

The signal adder 5340 adds magnitudes of the component carriers received from the signal magnitude calculator 330 to generate an envelope signal. For example, when the magnitudes of the component carriers received from the signal magnitude calculator 330 are |x1|, |x2|, |x3|, |x4| and |x5|, the signal adder 5340 adds all magnitudes of the component carriers to generate an envelope signal (y) as shown in Equation 3.

y=|x1|+|x2|+|x3|+|x4|+|x5| Equation 3

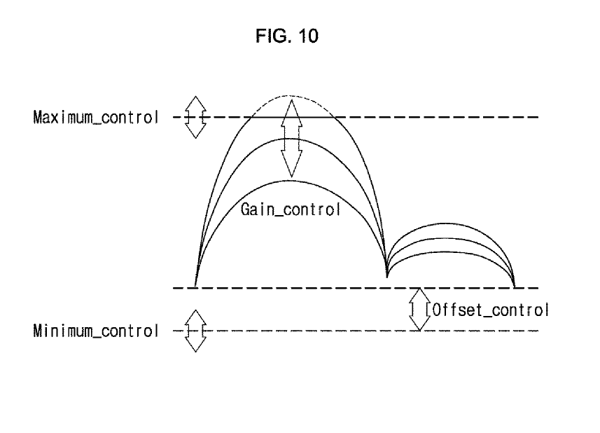

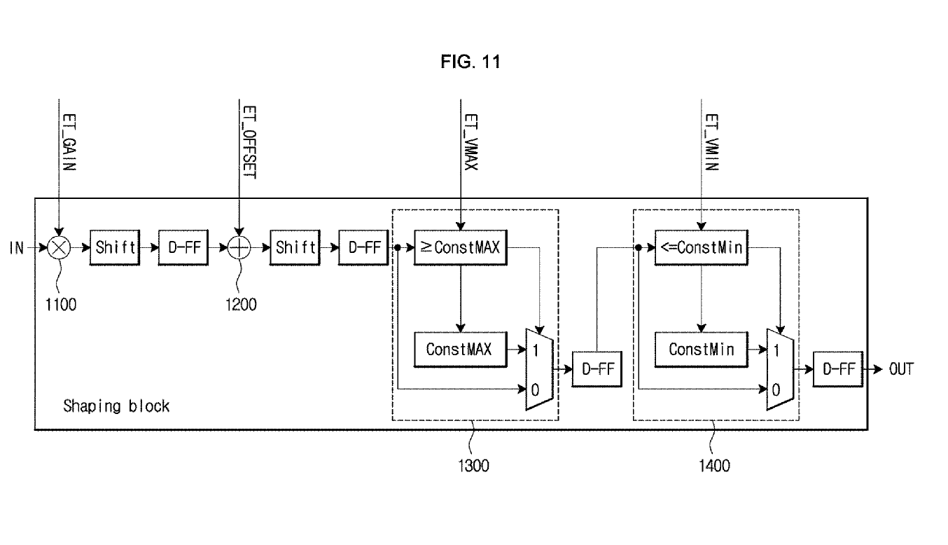

The signal shaper 5350 converts the magnitude of the envelope signal (y) received from the signal adder 5340 to a value corresponding to a bias voltage of the power amplifier 400. The signal shaper 5350 may shape the envelope signal by using various variable values. This will be further described with reference to FIG. 10 and FIG. 11 below.

The delayer 5360 matches synchronization between the RF path 200 and the ET path 5300. The delayer 5360 may, for example, match synchronization of the RF path 200 and the ET path 300 by integer multiple or decimal multiple of a reference clock.

The DAC_ET 5370 converts the envelope signal in a digital form to the envelope signal in an analog form.

The low pass filter 5380 eliminates noise signals except the envelope signal.

The ET modulator 5390 modulates the envelope signal to a bias voltage of the power amplifier 400.

The power amplifier 400 power-amplifies the RF signal received from the RF path 200 according to the bias voltage received from the ET modulator 5390.

When it is compared to the embodiment described with reference to FIG. 4, the envelope signal having a bandwidth of 60 MHz which is decreased by about 5 times in the bandwidth is generated by the ET path 5300. This is because that the component carriers included in the carrier aggregation signal are signals generated around DC voltage and the envelope signal of the carrier aggregation signal is signal present around DC voltage. According to the above described embodiment, the ET path 5300 may be configured by using elements having a low supporting bandwidth, which means that the envelope tracking may be applied by using general elements which are conventionally used.

An embodiment using the component carriers which belong to an intra-band was described with reference to FIG. 5. A case using component carriers which belong to an inter-band may be applied to the configuration illustrated in FIG. 5. However, in case of an inter-band of which a frequency distance between frequency bands is far, it may be needed to use the power amplifiers which cover each frequency band. For example, it is assumed that a component carrier belonging to a frequency band A and a component carrier belonging to a frequency band B are used, it requires 2 power amplifiers for each frequency band and a baseband processor, an RF path and an ET path are also required for each power amplifier. This means that component carriers belonging to the inter-band can be treated by using the configuration illustrated in FIG. 5 twice.

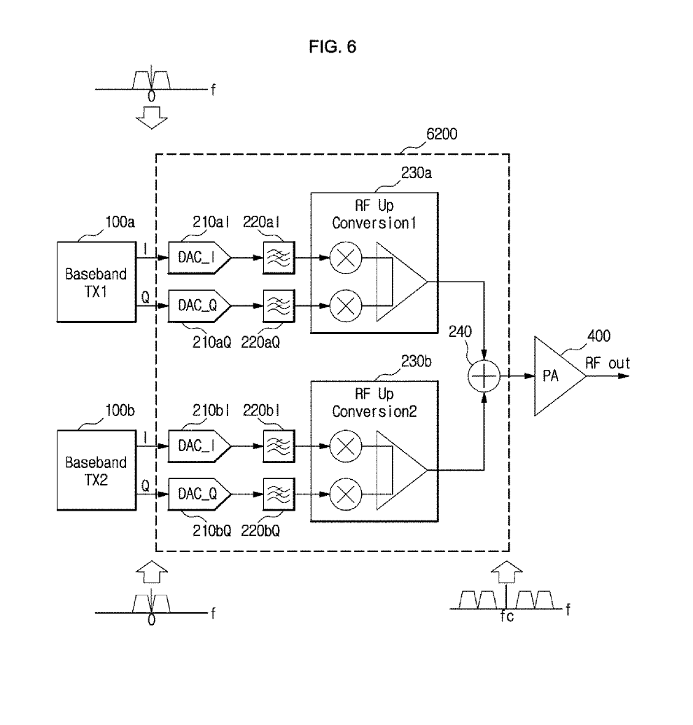

FIG. 6 is a block view illustrating another RF transmitter in which carrier aggregation is applied. FIG. 6 illustrates that component carriers of the first group of which frequency bands are contiguous and component carriers of the second group of which frequency bands are contiguous are aggregated to be RF-treated. Here, it is assumed that any one component carrier of the first group and any one component carrier of the second group are non-contiguous with each other and belong to intra-bands. Referring to FIG. 6, an RF transmitter comprises baseband processors, an RF path 6200 and a power amplifier 400.

The baseband processor comprises a first baseband processor 100a and a second baseband processor 100b. Each of the first baseband processor 100a and the second baseband processor 100b aggregates a plurality of component carriers having a bandwidth to generate a carrier aggregation signal and outputs the generated carrier aggregation signal to the RF path 6200.

For example, the first baseband processor 100a aggregates 2 component carriers, each having a bandwidth of 20 MHz, to generate a carrier aggregation signal having a bandwidth of 40 MHz and outputs the generated carrier aggregation signal to the RF path 6200. The second baseband processor 100b aggregates 2 component carriers, each having a bandwidth of 20 MHz, to generate a carrier aggregation signal having a bandwidth of 40 MHz and outputs the generated carrier aggregation signal to the RF path 6200.

The RF path 6200 RF-treats the carrier aggregation signals received from the baseband processors. The RF path 6200 comprises a plurality of digital to analog converters, a plurality of low pass filters, a plurality of RF up converters and an RF combiner.

Each of the digital to analog converters 210aI, 210aQ converts digital I/Q signals received from the first baseband processor 100a to analog signals. Each of the digital to analog converters 210bI, 210bQ converts digital I/Q signals received from the second baseband processor 100b to analog signals.

Each of low pass filters 220aI, 220aQ eliminates noise signals except the transmission signal from the analog I/Q signals received from the digital to analog converters 210aI, 210aQ.

Each of low pass filters 220bI, 220bQ eliminates noise signals except the transmission signal from the analog I/Q signals received from the digital to analog converters 210bI, 210bQ.

The RF up converters 230a, 230b up-converts the transmission signal present around DC voltage to a desired channel frequency.

The RF combiner 240 aggregates the RF signals received from the RF up converters 230a, 230b.

The power amplifier 400 power-amplifies the RF signals received from the RF combiner 240.

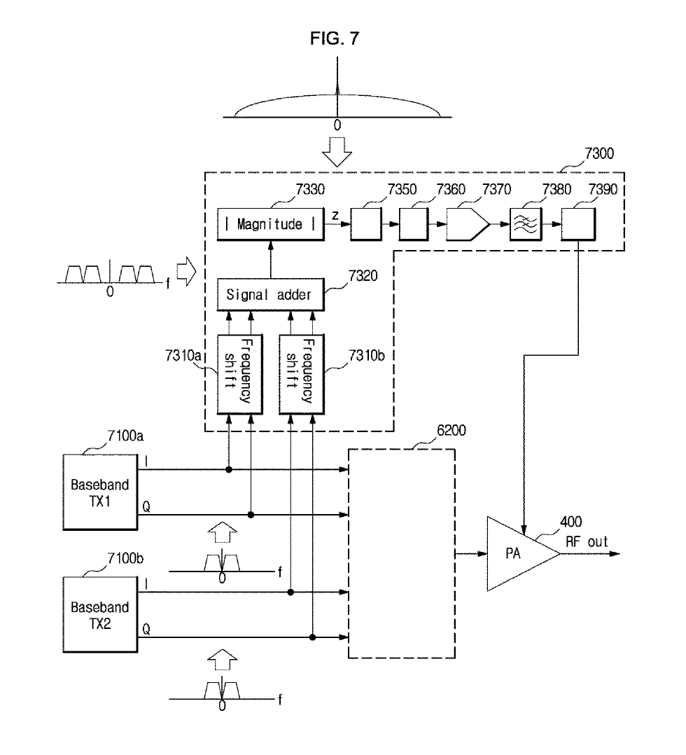

FIG. 7 is a block view illustrating an RF transmitter in which carrier aggregation and envelope tracking are applied according to another embodiment of the present invention.

FIG. 7 illustrates that component carriers of the first group of which frequency bands are contiguous and component carriers of the second group of which frequency bands are contiguous are aggregated to be RF-treated as in FIG. 6. Here, it is assumed that any one component carrier of the first group and any one component carrier of the second group are non-contiguous with each other and belong to intra-bands.

Referring to FIG. 7, an RF transmitter according to another embodiment of the present invention comprises baseband processors, an RF path 6200, an ET path 7300 and a power amplifier 400. Detail description of the RF path 6200 will be omitted since it is the same as described with reference to FIG. 6

The baseband processor comprises a first baseband processor 7100a and a second baseband processor 7100b. Each of the first baseband processor 7100a and the second baseband processor 7100b aggregates a plurality of component carriers having a bandwidth to generate a carrier aggregation signal and outputs each generated carrier aggregation signal to the RF path 6200 and the ET path 7300.

For example, the first baseband processor 7100a aggregate 2 component carriers, each having a bandwidth of 20 MHz, to generate a carrier aggregation signal having a bandwidth of 40 MHz and outputs the generated carrier aggregation signal to the RF path 6200 and the ET path 7300. The second baseband processor 7100b aggregate 2 component carriers, each having a bandwidth of 20 MHz, to generate a carrier aggregation signal having a bandwidth of 40 MHz and outputs the generated carrier aggregation signal to the RF path 6200 and the ET path 7300.

The ET path 7300 generates an envelope signal by the envelope tracking. The envelope signal is used to generate a bias voltage to be provided to the power amplifier 400. The envelope signal is used for the power amplifier 400 to power-amplify the RF signal which is converted by the RF path 6200. The ET path 7300 comprises frequency shifters 7310a, 7310b, a signal adder 7320, a signal magnitude calculator 7330, a signal shaper 7350, a delayer 7360, a DAC_ET 7370, a low pass filter 7380 and an ET modulator 7390. According to embodiments, at least one component thereof may be omitted.

Each of the frequency shifters 7310a, 7310b frequency-shifts the carrier aggregation signals received from the first baseband processor 7100a and the second baseband processor 7100b based on a set frequency band. The set frequency band may be a frequency band of any one component carrier among the component carriers included in the carrier aggregation signal. The set frequency band may be also a predetermined frequency band.

The signal adder 7320 adds signals received from the frequency shifters 7310a, 7310b to generate one aggregated signal.

The signal magnitude calculator 7330 calculates magnitudes (z) of the aggregated signals received from the signal adder 7320. The magnitudes (z) may be calculated by the Equation 1.

Detail descriptions of the signal shaper 7350, the delayer 7360, the DAC_ET 7370, the low pass filter 7380 and the ET modulator 7390 will be omitted since they are the same as described with reference to FIG. 5.

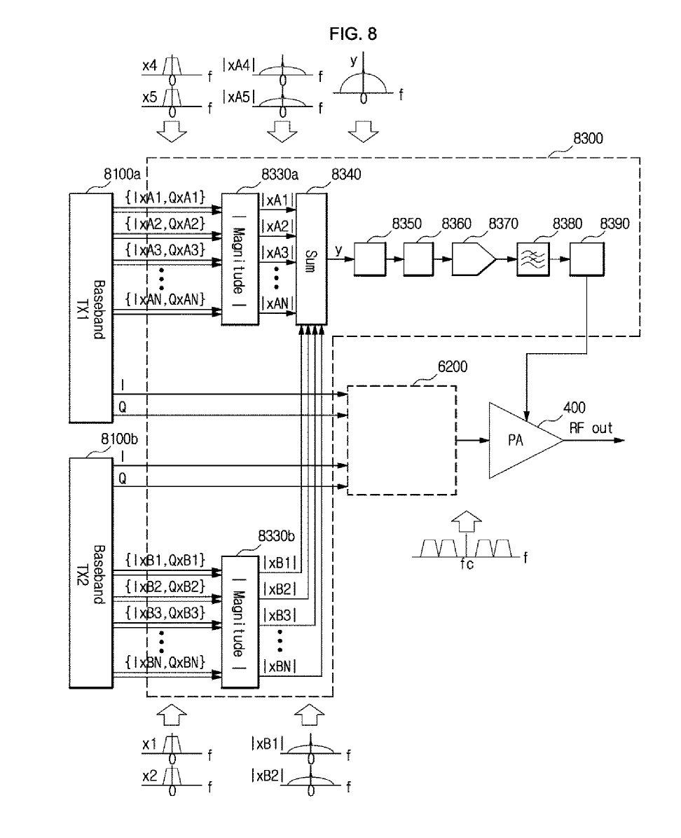

FIG. 8 is a block view illustrating an RF transmitter supporting carrier aggregation and envelope tracking according to still another embodiment of the present invention.

FIG. 8 illustrates that component carriers of the first group of which frequency bands are contiguous and component carriers of the second group of which frequency bands are contiguous are aggregated to be RF-treated like FIG. 6. Here, it is assumed that any one component carrier of the first group and any one component carrier of the second group are non-contiguous with each other and belong to intra-bands.

Referring to FIG. 8, an RF transmitter according to still another embodiment of the present invention comprises baseband processors, an RF path 6200, an ET path 8300 and a power amplifier 400. Detail description of the RF path 6200 will be omitted since it is the same as described with reference to FIG. 6.

The baseband processor comprises a first baseband processor 8100a and a second baseband processor 8100b.

Each of the first baseband processor 8100a and the second baseband processor 8100b outputs one or more component carriers to the ET path 8300.

Each of the first baseband processor 8100a and the second baseband processor 8100b aggregates one or more component carriers to generate a carrier aggregation signal (hereinafter, referred to as “first carrier aggregation signal” for the carrier aggregation signal generated by the first baseband processor 8100a and the second baseband processor 8100b) and outputs the generated first carrier aggregation signal to the RF path 6200.

The RF path 6200 may aggregate the first carrier aggregation signals received from the first baseband processor 8100a and the second baseband processor 8100b to generate a carrier aggregation signal (hereinafter, referred to as “second carrier aggregation signal” for the carrier aggregation signal generated by the RF path 6200).

For example, the first baseband processor 8100a outputs 2 component carriers, each having a bandwidth of 20 MHz, included in the first group to the ET path 8300, and aggregates the 2 component carriers to generate the first carrier aggregation signal having a bandwidth of 40 MHz and outputs the generated first carrier aggregation signal to the RF path 6200. The second baseband processor 8100b outputs 2 component carriers, each having a bandwidth of 20 MHz, included in the second group to the ET path 8300, and aggregates the 2 component carriers to generate the first carrier aggregation signal having a bandwidth of 60 MHz and outputs the generated first carrier aggregation signal to the RF path 6200. A second carrier aggregation signal may be generated in the RF path 6200 by using the first carrier aggregation signal having a bandwidth of 40 MHz generated in the first baseband processor 8100a and the first carrier aggregation signal having a bandwidth of 40 MHz generated in the second baseband processor 8100b. Here, some of the component carriers included in the second carrier aggregation signal generated in the RF path 6200 may have frequency bands that are not contiguous with one another.

The ET path 8300 generates an envelope signal which is used to power-amplify the RF signal converted by the RF path 6200. The ET path 8300 comprises signal magnitude calculators, a signal adder 8340, a signal shaper 8350, a delayer 8360, a DAC_ET 8370, a low pass filter 8380 and an ET modulator 8390. According to embodiments, at least one component thereof may be omitted.

The signal magnitude calculators comprise a first signal magnitude calculator 8330a and a second signal magnitude calculator 8330b. Each of the first signal magnitude calculator 8330a and the second signal magnitude calculator 8330b calculates each magnitude of the component carriers received from the first baseband processor 8100a and the second baseband processor 8100b.

That is, the first signal magnitude calculator 8330a calculates magnitudes (|xA1|, . . . , |xAN|) of each of the component carriers (xA1, . . . , xAN) received from the first baseband processor 8100a and the second signal magnitude calculator 8330b calculates magnitude (|xB1|, . . . , |xBN|) of each of the component carriers (xB1, . . . , xBN) received from the second baseband processor 8100b. In an embodiment, magnitudes of the component carriers may be calculated by the following Equation 4.

|xAn|=\sqrt{I²_{xAn}+Q²_{xAn}}
(wherein, n⊂N)

|xBm|=\sqrt{I²_{xBm}+Q²_{xBm}} Equation 4
(wherein, n⊂N)

For example, it is assumed that component carriers (xA4, xA5) and component carriers (xB1, xB2) are outputted from the baseband processor 8100a and the baseband processor 8100b, respectively.

Here, the first signal magnitude calculator 8330a calculates magnitudes (|xA4|, |xA5|) of the component carriers (xA4, xA5) as shown in Equation 5. The second signal magnitude calculator 8330b calculates magnitudes (|xB1|, |xB2|) of the component carriers (xB1, xB2) as shown in Equation 6.

|xA4|=\sqrt{I²_{xA4}+Q²_{xA4}}

|xA5|=\sqrt{I²_{xA5}+Q²_{xA5}} Equation 5

|xB1|=\sqrt{I²_{xB1}+Q²_{xB1}}

|xB2|=\sqrt{I²_{xB2}+Q²_{xB2}} Equation 6

The signal adder 8340 adds the signal magnitudes (|xA1|, . . . , |xAN|) received from the first signal magnitude calculator 8330a and the signal magnitudes (|xB1|, . . . , |xBN|) received from the second signal magnitude calculator 8330b to generate an envelope signal (y) as shown in Equation 7.

y=|xA1|+|xA2|+ . . . +|xAN|+|xB1|+|xB2|+ . . . +|xBN| Equation 7

When the magnitudes of the component carriers received from the signal magnitude calculator 8330a are |xA4| and |xA5| and the magnitudes of the component carriers received from the signal magnitude calculator 8330b are |xB1| and |xB2|, an envelope signal (y) may be provided by the following Equation 8.

y=|xA4|+|xA5|+|xB1|+|xB2| Equation 8

Detail descriptions of the signal shaper 8350, the delayer 8360, the DAC_ET 8370, the low pass filter 8380 and the ET modulator 8390 will be omitted since they are the same as described with reference to FIG. 5.

The power amplifier 400 power-amplifies the RF signal which is received from RF path 6200 according to the bias voltage received from the ET modulator 8390.

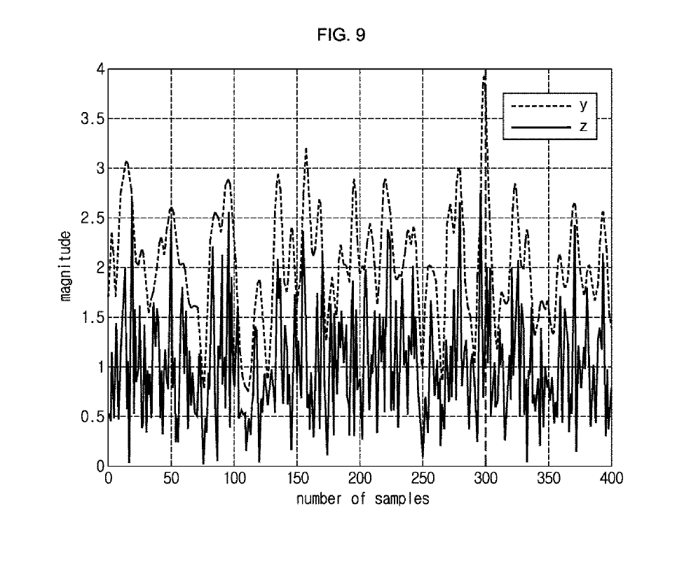

FIG. 9 illustrates an envelope signal (z) generated according to an embodiment described with reference to FIG. 4 and FIG. 7 and an envelope signal (y) generated according to an embodiment described with reference to FIG. 5 and FIG. 8.

Referring to FIG. 9, it is noted that magnitude of the envelope signal (y) is greater than that of the envelope signal (z). This does not thus cause any signal distortion which is caused when the bias voltage of the power amplifier is less than magnitude of the transmission signal (RF signal).

In embodiments described with reference to FIG. 5, FIG. 7 and FIG. 8, the signal shaper may shape an envelope signal by using a plurality of variable values and this will be explained with reference to FIG. 10 and FIG. 11 below.

FIG. 10 illustrates a signal shaping process according to exemplary embodiments of the present invention.

For example, as shown in FIG. 10, the signal shaper may control an envelope signal to be proportional to magnitude of the RF transmit power by using a gain value (ET_GAIN). Furthermore, the signal shaper may increase/decrease an output DC level of an envelope signal by using an offset value (ET_OFFSET). The signal shaper may also shape an envelope signal by using the maximum threshold (ET_MAX) and the minimum threshold (ET_MIN). This allows the ET modulator to generate the maximum bias voltage and the minimum bias voltage in which the power amplifier is operable.

FIG. 11 is a block view illustrating a signal shaper according to an embodiment of the present invention.

The signal shaper comprises a multiplier 1100 configured to shape an envelope signal according to a gain value (ET_GAIN), an adder 1200 configured to control an output DC level of the envelope signal according to an offset value (ET_OFFSET), a first block 1300 configure to control a maximum value of the envelope signal, and a second block 1400 configure to control a minimum value of the envelope signal. According to embodiments, at least one component thereof may be omitted.

When a maximum value of an envelope signal is greater than a predetermined maximum threshold (ET_MAX), the first block 1300 may shape the envelope signal to be that the maximum value of the envelope signal is equal to the maximum threshold (ET_MAX). On the other hand, when a maximum value of an envelope signal is less than a predetermined maximum threshold (ET_MAX), the first block 1300 may not shape the envelope signal.

When a minimum value of an envelope signal is greater than a predetermined minimum threshold (ET_MIN), the second block 1400 may not shape the envelope signal. On the other hand, when a minimum value of an envelope signal is less than a predetermined minimum threshold (ET_MIN), the second block 1400 may shape the envelope signal to be that the minimum value of the envelope signal is equal to the minimum threshold (ET_MIN).

The spirit of the present invention has been described by way of example hereinabove, and the present invention may be variously modified, altered, and substituted by those skilled in the art to which the present invention pertains without departing from essential features of the present invention. Accordingly, the exemplary embodiments disclosed in the present invention and the accompanying drawings do not limit but describe the spirit of the present invention, and the scope of the present invention is not limited by the exemplary embodiments and accompanying drawings. The scope of the present invention should be interpreted by the following claims and it should be interpreted that all spirits equivalent to the following claims fall within the scope of the present invention.

What is claimed is:

1. An RF (radio frequency) transmitter comprising:
an RF path configured to convert a carrier aggregation signal in which a plurality of component carriers belonging to a baseband are aggregated into an RF signal;
an ET path configured to generate an envelope signal by calculating magnitudes of the plurality of component carriers, respectively, and adding the calculated magnitudes of the component carriers; and
an amplifier configured to power-amplify the converted RF signal according to a bias voltage corresponding to the generated envelope signal.

2. The RF transmitter of claim 1, further comprising a baseband processor configured to output the carrier aggregation signal to the RF path and output each of the plurality of component carriers to the ET path.

3. The RF transmitter of claim 2, wherein the ET path comprises a signal magnitude calculator configured to calculate each magnitude of the component carriers received from the baseband processor; and
an adder configured to add signals received from the signal magnitude calculator.

4. The RF transmitter of claim 1, wherein any one component carrier of the plurality of component carriers has a frequency band that is contiguous with a frequency band of at least one another component carrier.

5. The RF transmitter of claim 1, wherein the ET path comprises a signal shaper configured to shape the generated envelope signal by using a predetermined variable value.

6. The RF transmitter of claim 5, wherein the variable value comprises at least one of a gain value which is used to shape magnitude of the envelope signal, an offset value which is used to increase/decrease an output DC level of the envelope signal, a maximum threshold which is used to limit a maximum value of the envelope signal, and a minimum threshold which is used to limit a minimum value of the envelope signal.

7. An RF transmitter comprising:
an RF path configured to convert a first baseband signal and a second baseband signal into one radio frequency signal, the first baseband signal and the second baseband signal each comprising at least one component carrier;
an ET path configured to generate an envelope signal by calculating magnitudes of the component carriers, respectively, included in the first baseband signal and the second baseband signal and adding the calculated magnitudes of the component carriers; and
an amplifier configured to power-amplify the converted RF signal according to a bias voltage corresponding to the generated envelope signal.

8. The RF transmitter of claim 7, further comprising:
a first baseband processor configured to output the first baseband signal to the RF path and output each component carrier included in the first baseband signal to the ET path; and
a second baseband processor configured to output the second baseband signal to the RF path and output each component carrier included in the second baseband signal to the ET path.

9. The RF transmitter of claim 8, wherein the ET path comprises:
a first signal magnitude calculator configured to calculate magnitudes of the component carriers, respectively, received from the first baseband processor;
a second signal magnitude calculator configured to calculate magnitudes of the component carriers, respectively, received from the second baseband processor; and
an adder configured to add signals received from the first signal magnitude calculator and the second signal magnitude calculator.

10. The RF transmitter of claim 7, wherein the component carriers included in the first baseband signal have frequency bands that are contiguous and the component carriers included in the second baseband signal have frequency bands that are contiguous.

11. The RF transmitter of claim 7, wherein any one component carrier included in the first baseband signal has a frequency band that is not contiguous with a frequency band of any one component carrier included in the second baseband signal.

12. The RF transmitter of claim 7, wherein the RF signal converted in the RF path is a carrier aggregation signal in which the first baseband signal and the second baseband signal are aggregated.

13. The RF transmitter of claim 12, wherein some of the component carriers included in the carrier aggregation signal have frequency bands that are not contiguous with one another.

14. The RF transmitter of claim 7, wherein the ET path comprises a signal shaper configured to shape the generated envelope signal by using a predetermined variable value.

15. The RF transmitter of claim 14, wherein the variable value comprises at least one of a gain value which is used to shape magnitude of the envelope signal, an offset value which is used to increase/decrease an output DC level of the envelope signal, a maximum threshold which is used to limit a maximum value of the envelope signal, and a minimum threshold which is used to limit a minimum value of the envelope signal.

16. An RF transmitter comprising:
an RF path configured to convert a first baseband signal and a second baseband signal into one radio frequency signal, the first baseband signal and the second baseband signal each comprising at least one component carrier;
an ET path configured to generate an envelope signal by frequency shifting the component carriers included in the first baseband signal and the second baseband signal based on a set frequency band, aggregating the frequency shifted signals, and calculating magnitude for the aggregated signal; and
an amplifier configured to power-amplify the converted RF signal according to a bias voltage corresponding to the generated envelope signal.

17. The RF transmitter of claim 16, wherein any one component carrier included in the first baseband signal has a frequency band that is not contiguous with a frequency band of any one component carrier included in the second baseband signal.

18. The RF transmitter of claim 16, wherein the ET path comprises a signal shaper configured to shape the generated envelope signal by using a predetermined variable value.

19. The RF transmitter of claim 17, wherein the variable value comprises at least one of a gain value which is used to shape magnitude of the envelope signal, an offset value which is used to increase/decrease an output DC level of the envelope signal, a maximum threshold which is used to limit a maximum value of the envelope signal, and a minimum threshold which is used to limit a minimum value of the envelope signal.
